(19) United States
(12) Patent Application Publication
(10) Pub. No.: US 2023/0120405 A1
(43) Pub. Date: Apr. 20, 2023

(54) CONTAINER ARRANGEMENT

(71) Applicant: Gaplast GmbH, Altenau (DE)

(72) Inventors: Stephan Kneer, Farchant (DE); Roland Kneer, Farchant (DE); Kasim Yilginc, Oberammergau (DE)

(21) Appl. No.: 17/941,453

(22) Filed: Sep. 9, 2022

(30) Foreign Application Priority Data
Oct. 19, 2021 (DE) 10 2021 127 076.6

(51) Int. Cl. B65D 51/30; B65D 39/00

(52) U.S. Cl. CPC B65D 51/30; B65D 39/0017; A61J 1/00

(57) ABSTRACT

A container arrangement is provided and is configured to maintain a predetermined amount of moisture in the container for storing a product, where the container arrangement includes a container with an upper container opening and a closed base, a stopper with a central hole for fastening the stopper to the container opening, a hollow chamber with a peripheral wall, an upper wall with a central hole and a lower perforated base wall, where the chamber is put together with the stopper so that the central holes are in alignment with one another and a substance is arranged in the chamber, where the substance is a consequence of the inflow of ambient air through the central holes, and gives off water, which passes through the perforated base wall.

The invention relates to a container arrangement, which is configured to maintain a predetermined moisture for storing a product in the container.

With some products, for instance of vegetable type for pharmaceutical or health purposes, it is necessary, when being stored in a container, to maintain a substantially constant moisture in the container. The products are supposed thereby to maintain their freshness and their optical appearance, their smell and their taste. The respective ideal air humidity in the container depends on the nature of the product in question and its tendency to absorb moisture. Many products can be consumed or used over a relatively long period of time, whereby it is desirable or necessary that they retain the original freshness, the taste, smell or other properties in order to maintain their storage life.

It is the object of the present invention to provide a container arrangement, in which products, such as pharmaceuticals and herbs can be stored, even for a relatively long period of time, and thereby retain their original properties to the greatest possible extent.

This object is solved in accordance with the invention by the features of claim 1.

Advantageous embodiments of the invention are characterised in the dependent claims.

The invention provides that the container arrangement includes a container with a container opening, a stopper or a closure cap with a preferably central hole passing through it for fastening to the container opening, and a hollow chamber, which includes an upper wall with a hole, which is also preferably central, and a lower, perforated base wall, wherein the chamber is put together with the stopper or the closure cap so that the two holes are in alignment with one another. The invention provides further that arranged in the chamber there is a substance, which, as a consequence of contact with the ambient air entering through the holes, gives off water, which passes through the perforated base wall to the stored product. The amount of the substance in the chamber, its capacity to separate water by a chemical process through contact with the ambient air flowing in through the holes and the perforation of the base wall are to be adjusted so that the necessary moisture is retained for the product in question. The duration of the storage at a substantially constant relatively air humidity depends on the chemical decomposition process of the substance introduced into the chamber.

The product in question can accordingly be stored with the container arrangement in accordance with the invention at a constant, predetermined moisture level. Since the interior of the container is in communication with the outer surroundings of the container as a result of the central holes in the stopper/closure cap and in the chamber and due to the base wall of the chamber provided with small holes, pressure differences in the container, which can be caused e.g. by temperature variations or organic processes in the product to be stored, can also be balanced out. Due to the fact that certain ventilation of the stored product occurs, the production of unpleasant odours and potentially the production of mould, as can occur with containers hermetically sealed from the exterior, can also be prevented.

In the container arrangement in accordance with the invention, the surrounding air, which passes into the container through the holes in the stopper/closure cap and in the chamber, serves not only to initiate a chemical decomposition process of the substance introduced into the chamber with the separation of water, but the surrounding air can also flow through a suitable perforation of the base wall of the chamber to the product disposed in the bottom of the container and in this manner prevent e.g. the production of a “musty” odour of the product.

The stopper can have a cavity on its underside, into which the entire chamber or its upper portion is inserted. Alternatively, the chamber can be secured to the underside of a closure cap, e.g. with retaining arms.

All common stoppers and closure caps can be used, to which a chamber can be secured in any convenient manner.

The two, preferably central, holes can be advantageously connected together by a connecting tube, which can be fastened to the wall of the chamber or to the underside of the stopper, and engages in the opposing hole.

The chamber consists conveniently of upper and lower portions, which are plugged into one another or are screwed together. In this manner, the provided substance can be introduced into the chamber in a simple manner.

It is also preferred that the container, the stopper and the chamber consist of plastic material and that these components have a circular basic shape.

Different substances can be considered for producing the water. In accordance with a first proposal, the substance consists of a mixture of sodium bicarbonate and citric acid, the ratio of which is to be matched variably to the individual case. On contact with moisture from the air or from the condensed substance, which is situated in the container, the two chemicals react with moisture (H₂O) to form sodium citrate, water and carbon dioxide. The carbon dioxide can pass out of the stopper opening and the moisture or the water released into the lower portion of the container. The sodium citrate remains in the chamber in the form of a solid material.

In accordance with an alternative proposal, the substance introduced into the chamber consists of hydrogen peroxide, the concentration of which is variable. The hydrogen peroxide decomposes in the air to form oxygen and water. The oxygen escapes through the openings into the surroundings and the water remains in the chamber, whereby it releases moisture into the lower portion of the container.

In accordance with a further proposal of the invention, the chamber can be filled with lithium hydroxide, which reacts with carbon dioxide to form lithium carbonate and water. The water is delivered through the perforated base whilst the lithium carbonate remains in the chamber in the form of a solid material.

Hydrogel (based on polyvinyl alcohol or sodium alginate) is also proposed as an alternative substance, which can give up water over a period of time and crystallizes out at the hole opening directed towards the air and forms a gas and air barrier. The moisture thus remains in the container.

The variants 1 to 3 mentioned above can be introduced into the chamber in the form of pure powder/liquid or can be incorporated in polyvinyl alcohol or in a hydrogel or in sodium alginate. The moisture supplying function can thereby be maintained for a longer period of time.

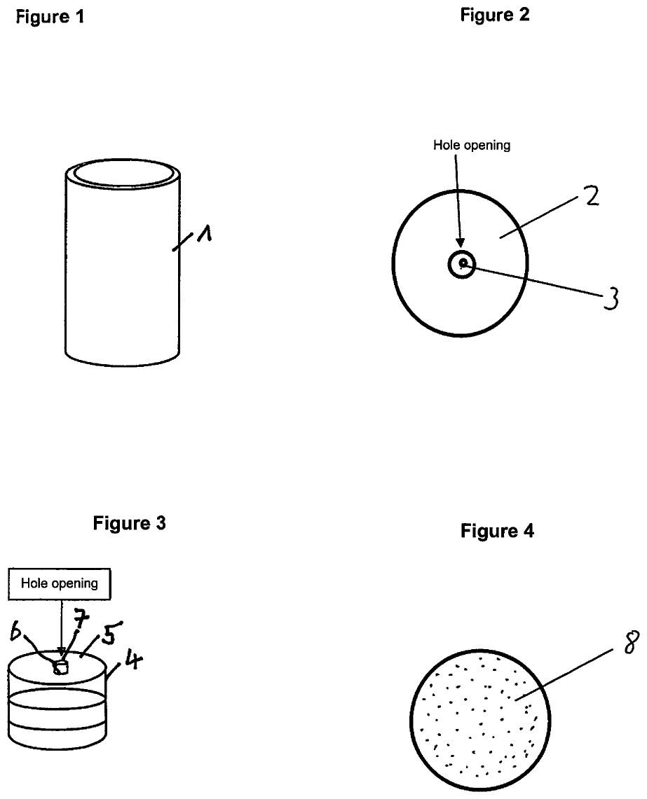

FIGS. 1 to 4 show in a schematic manner the three components of one embodiment of the container arrangement in accordance with the invention, in which:

FIG. 1 is a perspective view of a circular cylindrical container 1;

FIG. 2 is a plan view of a stopper 2 with a central through hole 3;

FIG. 3 is a perspective view of a hollow chamber or bag, which is preferably a cylindrical bag 4, formed in whose upper wall 5 there is also a central through opening 6, projecting upwardly from the edge of which there is a short tube connecting piece 7 and

FIG. 4 is a view from below of the perforated base 8 of the chamber 4.

1. A container arrangement which is configured to maintain a predetermined moisture in the container for storing a product, the container arrangement comprising:
a container with an upper container opening and a closed base;
a stopper with a central hole passing through the stopper for fastening the stopper to the upper container opening;
a hollow chamber, respectively, with a peripheral wall, an upper wall with a central hole and a lower perforated base wall, wherein the chamber, is se-put together with the stopper so that the central holes are in alignment with one another and that arranged in the chamber is a substance, which, as a consequence of the inflow of ambient air through the central holes, and gives off water, which passes through the perforated base wall.

2. The container arrangement as claimed in claim 1, wherein the chamber is fastened to the underside of the stopper.

3. The container arrangement as claimed in claim 1, wherein the central holes are connected together by a connecting tube, which is fastened to the wall of the chamber or to the underside of the stopper and engages in an opposing hole.

4. The container arrangement as claimed in claim 1, wherein the substance is a mixture of sodium bicarbonate and citric acid.

5. The container arrangement as claimed in claim 1, wherein the substance is hydrogen peroxide.

6. The container arrangement as claimed in claim 1, wherein the substance is lithium hydroxide.

7. The container arrangement as claimed in claim 1, wherein the substance is a hydrogel based on polyvinyl alcohol or sodium alginate.

8. The container arrangement as claimed in claim 1, wherein the substance is in powder form.

9. The container arrangement as claimed in claim 1, wherein the substance is used in liquid form.

10. The container arrangement as claimed in claim 4, wherein the substance is incorporated in polyvinyl alcohol or in a hydrogen or in sodium alginate.
